(19) United States
(12) Patent Application Publication
(10) Pub. No.: US 2006/0248746 A1
(43) Pub. Date: Nov. 9, 2006

(54) Device for determining the conductance of laundry, dryers and method for preventing deposits on electrodes

(75) Inventors: Lothar Dittmer, Berlin (DE); Harald Moschütz, Grobeeren (DE); Thomas Nawrot, Berlin (DE); Andreas Ziemann, Potsdam (DE)

Correspondence Address: JOHN T. WINBURN, 100 BOSCH BOULEVARD, NEW BERN, NC, 28562, US

(73) Assignee: BSH Bosch und Siemens Hausegeräte GmbH, Munich (DE)

(21) Appl. No.: 10/539,453

(22) PCT Filed: Dec. 20, 2003
(86) PCT No.: PCT/EP03/14177

§ 371 Date: May 1, 2006

(30) Foreign Application Priority Data
Dec. 20, 2002 (DE) 102 60 149.6

(51) Int. Cl. F26B 13/10; F26B 19/00

(52) U.S. Cl. 34/534; 34/528

(57) ABSTRACT

A device for determining the conductance of laundry in a drier. The device comprises at least two electrodes (2) and means for dissipating heat from at least one part of at least one of said electrodes (2). The invention further relates to a drier comprising at least one area (5) for receiving laundry and at least two electrodes (2) for measuring the conductance of the laundry, at least one of the electrodes (2) at least partly bordering said receiving area (5). Means for cooling at least one part of at least one of the electrodes (2) are also provided inside the drier. Also disclosed is a method for preventing the formation of layers on electrodes (2) used for measuring conductance in a drier.

The invention relates to a device for determining the conductance of laundry, a dryer and a method for preventing depositing on electrodes for conductance measuring.

In modern dryers, in particular in domestic dryers, the wash moisture in the laundry is measured for controlling the dryer, in particular for achieving desired residual moisture in the laundry. This measuring is preferably carried out according to the principle of conductance measuring.

As a rule two electrodes are applied to the laundry for this purpose, whereby one of the electrodes can represent for example the laundry drum and the second electrode can be a carrier installed against and insulated from the drum. Voltage is applied to the two electrodes via a resistor, and the result is a current through the laundry. The laundry voltage falling on the laundry is measured on the electrodes and from this determines the conductance, which is proportional to the moisture content in the laundry.

It was established in particular with fixed electrodes that a drift in measuring results had been set after repeated use. Tests have proven that this is caused by the development of deposits in the form of layers on the electrodes made by water contents and laundry substances. The transfer resistance occurring from the layers in addition is measured and the result of the wash moisture measuring is thus falsified by these layers, which for example can comprise lime and silicate, during measuring of the wash moisture. This means for example that targeted adjusting of residual moisture in the laundry is no longer guaranteed. On completion of the drying program the final residual moisture of the laundry is rather shifted in the direction of moister laundry. To remove the layers it was suggested to clean the electrode surfaces with acidic cleaning fluids so as to restore the functionality of the wash moisture measuring. This is expensive for one and also the electrodes can be difficult to access for the user, depending on the selected installation site.

The object of the invention is therefore to provide a device for measuring the wash moisture, a laundry dryer and a process for preventing layer build-up on electrodes in a laundry dryer, by means of which the development of layers on electrodes can be prevented or at least sharply reduced such that also precise determining of the wash moisture is enabled after repeated use, without the electrodes having to be cleaned by the user. In addition the device and the laundry dryer should have a simple construction.

The idea of the invention is that through targeted adjusting of a certain temperature on the electrode surfaces the build-up of layers can be prevented or at least decreased.

This task is therefore solved according to the present invention by a device for determining the conductance of laundry in a laundry dryer, which comprises at least two electrodes, whereby the device comprises means for heat elimination from at least one part of at least one of the electrodes.

In dryers a receiving area for the laundry to be dried is provided, which generally is a laundry drum. Through providing means for heat elimination from at least one part of the electrodes at least the surface of at least one of the electrodes, which is facing the receiving area or respectively borders on the latter, can be cooled. This drop in temperature of the electrodes can prevent evaporation of water on the electrodes, which can lead to the build-up of deposits of water contents and laundry fluids residues. A build-up of layers, which falsify the measuring results of the conductance measuring, can thus be prevented. In addition the condensation of moist-warm air in the drum interior on the electrodes can lead to the solution of water and laundry fluid contents on the electrodes being diluted and the fallout of dissolved minerals is prevented.

With means for heat elimination being provided on the rear of the electrodes particularly simple and advantageous heat elimination is guaranteed.

In one embodiment the means for cooling the electrodes represent means for improving radiation of heat from the electrodes. This embodiment is offered in cases where the electrodes are installed in positions, in which the side of the electrodes, averted from the drum interior, borders on a space, in which a lower temperature prevails than in the laundry drum. So for example the rear of the electrodes, that is, the side of the electrodes, facing away from the inside of the laundry drum, can be provided with a black coating, by which the radiation of heat in this direction is improved. It is also possible to improve the heat radiation by roughening the rear of the electrodes.

Alternatively or in addition the means can have cooling surfaces, which are connected to the electrodes. These cooling surfaces can lead, either by heat radiation or by additional cooling of the cooling surfaces by an appropriate coolant, such as for example air, to lowering of the temperature of the electrodes, in particular of the surface of the electrodes facing the drum interior.

According to the present invention the means for cooling the electrodes can also comprise means for air supply. By guiding colder air from other parts of the dryer along or onto the electrodes, in particular along or onto the electrode surface, facing the drum, the temperature of the electrodes can be lowered.

According to a preferred embodiment the means for air supply are formed by defined faulty air openings in the vicinity of the electrodes. Ambient air can be conveyed to the electrodes via these faulty openings. In terms of this invention passages are designated as faulty air openings, via which colder air from other areas of the dryer or respectively from its surroundings can be conveyed to the electrodes. The faulty air openings can also be designed in the form of pipes. The faulty air openings however preferably constitute gaps.

The means can also comprise an additional fan for raising the flow speed, or a source of pressurised air.

The electrodes of the inventive device are particularly preferably fixed in the laundry dryer. Due to this configuration costly contacting of the electrode, as is required for online electrodes, can be omitted. With the inventive device depositing on the electrodes can be avoided, although the elimination of deposits does not apply to a large extent through friction with the laundry, which is moved in the drum, as this occurs with carrier electrodes.

According to a further aspect of the invention the problem is solved by a laundry dryer, which comprises at least one receiving area for laundry and at least two electrodes for measuring the conductance of the laundry, whereby at least one of the electrodes borders at least partially on the receiving area, whereby means are provided in the laundry dryer for cooling at least a part of at least one of the electrodes.

The means used in the laundry dryer for heat elimination can be designed as described in Claims 2 to 6. These can thus comprise means for improving the radiation of heat, cooling surfaces, means for air supply or respectively a fan or a source of compressed air.

In one embodiment, with the inventive laundry dryer, in particular with the dryer according to the exhaust air type, means are provided, by which subpressure can be adjusted in the receiving area of the dryer. In addition to this the means for cooling in this embodiment constitute defined faulty air openings, via which the electrodes can be supplied with ambient air. The air supply in the inventive laundry dryer can be adjusted ideally by providing means for generating subpressure.

Colder ambient air can reach the electrodes and in particular the electrode surface via this subpressure through the faulty air openings. A fan can be used for example to generate the subpressure.

The build-up of deposits on the electrodes can easily be prevented by this adjusting of the air current into the laundry dryer.

The electrodes are preferably installed fixed in the laundry dryer.

The latter are arranged particularly preferably in the region of the front end shield. In this configuration the inventive effect of preventing the build-up on the electrodes can be utilised particularly advantageously, since other mechanisms can be utilised at this installation point only minimally for eliminating the layers, such as for example friction with the laundry in the drum.

The task is finally solved by a process for preventing layer deposits on electrodes for measuring moisture in a laundry dryer, whereby the temperature of the electrodes is controlled by means for heat elimination. The electrodes are preferably cooled at least partially by this.

The means for heat elimination, which can be used according to the present invention for controlling heat elimination, can be designed as in Claims 2 to 6. These can thus comprise means for improving the radiation of heat, cooling surfaces, means for air supply or respectively a fan or a source of compressed air.

It is particularly preferable to bring the electrodes to a temperature, which is below the processing temperature in the laundry dryer, preferably below the temperature of surfaces, adjacent to the electrodes. The difference in temperature is preferably set at least at one degree Kelvin (1 K). Adjoining surfaces are for example the front floor or the front drum mantle of the laundry drum. Whereas on the relatively cooler electrodes solutions of water and laundry fluids contents optionally applied by the laundry through condensation of the moist warm air are diluted, on the relatively warmer metallic surfaces in the environment the solution of evaporating water is further concentrated, which leads to the depositing of minerals and thus to forming of layers on these relatively warmer surfaces. The electrode surfaces required for the conductance measuring however remain free of deposits.

Cooling of the electrodes can be achieved in different ways. In one embodiment the electrodes are cooled by air cooling. The particular advantage of this type of cooling in which a focused cool-air supply is directed to at least one part of the electrodes is that the air located in the dryer outside the laundry drum can be used as coolant can and thus bringing more coolant into the laundry dryer is unnecessary. For this reason a preferred embodiment of the process in particular in dryers according to the exhaust air type is characterised in that subpressure is adjusted in a receiving area for laundry in the laundry dryer and the electrodes are supplied with cool air, in that ambient air is sent to the electrodes via defined faulty air openings.

The advantages and characteristics of the inventive device or respectively of the inventive dryer apply accordingly also for the inventive process and vice versa respectively.

The invention will be described hereinafter by means of the attached diagrams, which illustrate a non-limiting example of a possible embodiment of the invention, in which:

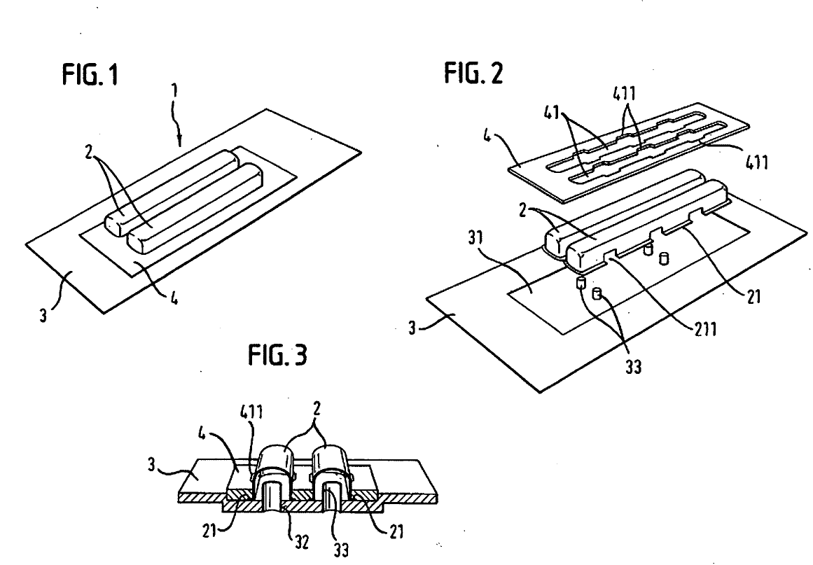

FIG. 1 is a perspective view of an embodiment of an inventive device for measuring wash moisture.

FIG. 2 is an exploded view of the embodiment of the inventive shown device in FIG. 1.

FIG. 3 is a schematic sectional view through the embodiment of the inventive device shown in FIG. 1.

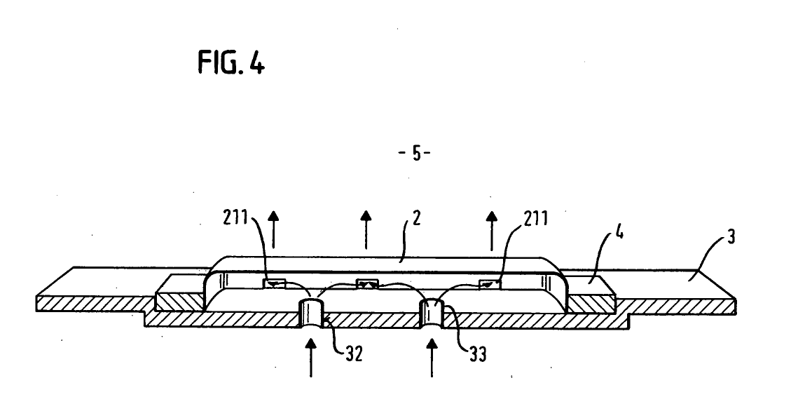

FIG. 4 is a schematic longitudinal view through the embodiment of the inventive device shown in FIG. 1.

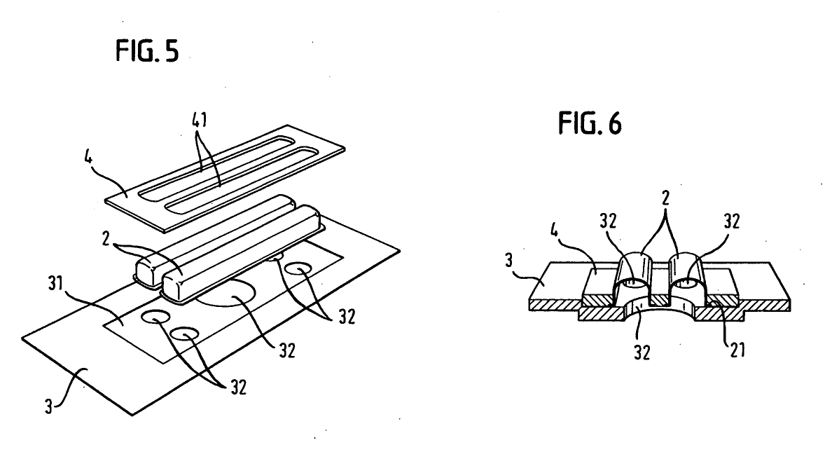

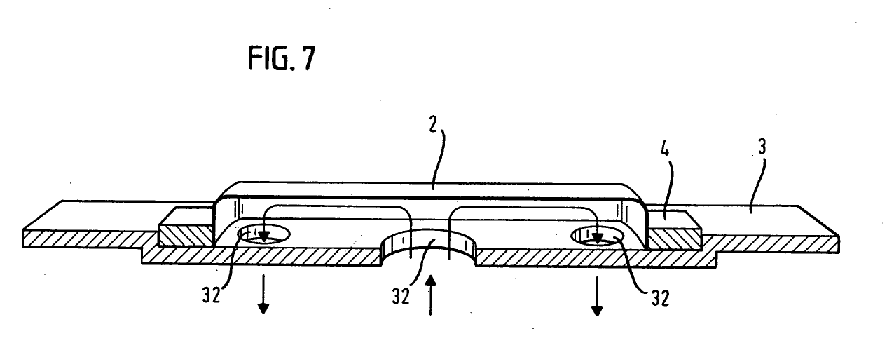

FIG. 5 to 7 illustrate an embodiment of an inventive device for measuring wash moisture compared to the modified device shown in FIGS. 2 to 4.

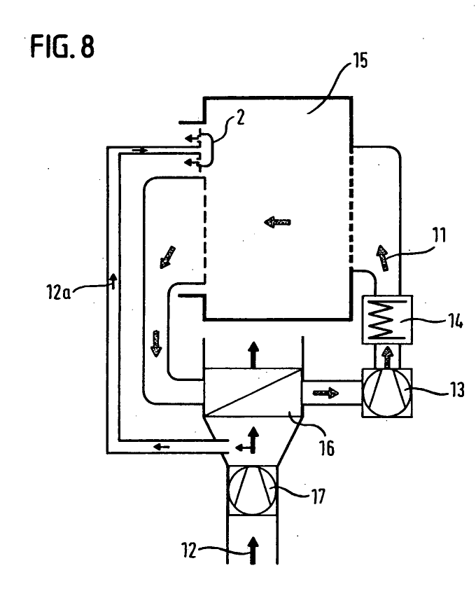

FIG. 8 shows a laundry dryer according to the condensation construction with an inventive device for measuring wash moisture.

FIG. 1 illustrates an embodiment of an inventive device 1 in perspective view. Devices for measuring the conductance are known extensively from the prior art, so that in the figures only elements of the device are shown, which are essential to the invention. The device 1 comprises two electrodes 2, which extend in each case longitudinally and are arranged parallel to one another. The electrodes 2 are held on one component 3, whereby a retaining frame 4 is provided for fastening the electrodes 2. This can be connected so as to latch with the component 3. The component 3 can for example constitute the front end shield or respectively a part of the mounting of the drum. As is evident from FIG. 2, the component 3 in the illustrated embodiment has a depression 31, which corresponds to the size of the retaining frame 4 and serves to receive the retaining frame 4. Provided in the depression 31 are openings 32, which extend through the component 3 and are provided in the illustrated design in each case with pipe extensions 33. The pipe extensions 33 extend in the state in which the electrodes 2 are fastened to the component 3, in the interior of the electrodes 2.

In contrast to the design illustrated in FIGS. 2 to 4 in FIGS. 5 to 7 the component 3 attached backwards to the electrodes 2 is provided with a central opening 32 for supplying cool air and with two side openings 32 for discharge of cool air. In this way the current of cool air enters in the centre and divides into two partial streams, so that uniform cooling of the electrodes is ensured.

The electrodes 2 in each case have a pan form, whereby the opening of the pan is facing the component 3. A flange 21, which is interrupted over the length of the electrodes 2 at several positions (in this case three) by recesses 211 extends outwards at the edge of the pan opening on each electrode 2. The recesses 211 preferably extend over the flange 21 in the direction of the pan floor of electrodes 2. The retaining frame 4 has two longitudinal grooves 41, corresponding to the form of the electrodes 2. Provided over the length of the longitudinal grooves 41 at positions, which correspond to the positions of the recesses 211 on the electrodes 2, are extensions 411 of the longitudinal groove 41.

As shown in FIG. 3, in the assembled state the pipe extensions 33, which are provided on the component 3, project into the interior of the electrodes 2, i.e. in the pan form, but do not contact the pan floor.

FIG. 4 shows a longitudinal section through the embodiment of the device 1 shown in FIG. 1. An embodiment of the inventive process will now be explained with reference to this diagram.

In a laundry dryer according to the exhaust air type, which works on the suction principle, a certain subpressure prevails in the laundry drum determined by the type of construction. Using the inventive device 1 in such a laundry dryer results in the following current behaviour. Colder air outside the drum is directed via the openings 32 in the component 3 and via the connected pipe extensions 33 into the interior of the pan-shaped electrodes 2. There the air flow is directed via the extensions 411 of the longitudinal grooves 41 in the retaining frame 4 thus cooperating via the recesses 211 on the electrodes 2 into the interior 5 of the laundry drum. By way of this air supply the inside of the electrodes is kept constantly cool. Each of the electrodes 2 experiences a certain cooling from this. In addition, the surface of the electrodes 2, facing the drum interior 5, is additionally cooled by cooler air brushing past this surface of the electrode 2. The cooling thus takes place via the channel formed by the openings 32, the pipe sections 33 and the inside of the electrodes 2, as well as via the defined gap leakage formed by the recesses 211 and extensions 411. This results in ideal cooling and fallout of minerals and the formation of layers, which falsify the measuring results, can thus be avoided.

FIG. 8 illustrates a laundry dryer according to the condensation type, which has a processing air stream 11 and a current of cool air 12 for cooling the processing air current 11. The processing air current 11 is guided via a fan 13, a heating unit 14, a drum 15, a slubbing sieve (not illustrated) and a condenser 16 in a closed circuit. The condenser 16 is cooled via the current of cool air 12 generated by means of a fan 17. A partial current of cool air 12a is branched off between the fan and the condenser from the current of cool air 12 and directed to the rear of the electrodes 2.

The current of cool air 12 for the condenser 16 can also be used for cooling the electrodes 2 in an advantageous manner.

The invention is not restricted to the illustrated embodiments. With the inventive device the air channel for flowing through the electrodes and flowing past the surface of the electrodes can also be formed by other means than the illustrated recesses and extensions. For example slots can be formed through which the colder air can reach the surface of the electrodes from the inside of the electrodes. Should the invention be realised on a dryer, which does not work according to the above suction principle, instead of using the subpressure in the laundry drum a fan can be used to guide cooler air to the electrodes from outside the drum via suitable channels or via defined gap leakages.

It is further possible to configure electrodes in such a way that they are provided on the side averted from the interior of the laundry drum with a coating, for example a black film, or cooling surfaces are provided on this side. If the electrodes are arranged for example in the region of the front end shield, these cooling surfaces can extend in the space between the end shield and the front wall of the unit.

Alternatively or additionally the flow rate of the air behind the electrodes can be increased, through which the elimination of heat of the electrodes can be increased and its temperature can thus be lowered.

With the inventive device, the laundry dryer and the inventive process a temperature difference between the electrodes and adjacent surfaces of at least 0.8 K, preferably at least 1 K and particularly preferably at least 1.2 K can preferably be set.

Also the form of the electrodes is not limited to the form in question. The electrodes can for example also be designed flat, or exhibit a v-shaped cross-section. Likewise, ways other than the above type of fastening of the electrodes can be used on the component. Known latching means can be considered for this purpose.

The cooling of the electrodes can, as can be inferred from the description, be carried out via direct cooling of the surface of the electrodes facing the drum interior. Alternatively or in addition to this the heat elimination and thus the cooling can take place indirectly via the rear side of the electrode.

In summary the present invention creates the possibility of reliably determining the conductance of laundry, which is to be dried in a dryer, without the user having to manually clean the electrodes used for measuring.

1-17. (canceled)

18. A device for determining the conductance of laundry in a laundry dryer, which comprises at least two electrodes, wherein the device comprises means for heat reduction from at least a part at least of one of the electrodes.

19. The device as claimed in claim 18, wherein the means for heat reduction are arranged on the rear of the electrodes.

20. The device as claimed in claim 18, wherein the means for heat reduction includes at least one of means for improving radiation of heat from the electrodes and cooling surfaces, which are connected to the electrodes.

21. The device as claimed in claim 18, wherein the means for heat reduction comprises means for air supply and the electrodes are arranged on a component in which openings are formed, cool air being supplied and removed from the electrodes, whereby the cool air is supplied through a middle opening and the cool air is removed through at least one side opening.

22. The device as claimed in claim 21, wherein the means for air supply are formed by defined faulty air openings in the vicinity of the electrodes, through which ambient air can be conveyed to the electrodes.

23. The device as claimed in claim 21, wherein the means for air supply comprises at least one of a fan and a source of compressed air.

24. The device as claimed in claim 18, wherein the electrodes are built fixed in the laundry dryer.

25. A laundry dryer, which comprises at least one receiving area for laundry and at least two electrodes for measuring the conductance of the laundry, whereby at least one of the electrodes at least partially borders on the receiving area, the laundry dryer including cooling means for cooling at least a part of at least one of the electrodes.

26. The device as claimed in claim 25, wherein the cooling means are arranged on the rear of the electrodes.

27. The device as claimed in claim 25, wherein the cooling means includes at least one of means for improving radiation of heat from the electrodes and cooling surfaces, which are connected to the electrodes.

28. The device as claimed in claim 25, wherein the cooling means comprises air supply means for supplying cool air flow and the electrodes are arranged on a component in which openings are formed, the cool air flow being supplied to the electrodes through a middle opening and the cool air flow being removed from the electrodes through at least one side opening.

29. The device as claimed in claim 28, wherein the air supply means include faulty air openings adjacent the electrodes, the cool air flow being conveyed to the electrodes through the faulty air openings.

30. The device as claimed in claim 21, wherein the air supply means comprises at least one of a fan and a source of compressed air.

31. The laundry dryer as claimed in claim 25, wherein cooling means includes an air supply means for providing a cool air flow, the air supply means including a sub-pressure being set in the receiving area, the cooling means including defined air openings adjacent the electrodes, the air supply means supplying cool air flow to the electrodes, the dryer comprising a condenser for condensing water, and the cool air flow passing through the condenser and at least a part of the cool air flow is also used for cooling the electrodes.

32. The laundry dryer as claimed in claim 25, wherein the electrodes are built in to the laundry dryer in the vicinity of a front end shield.

33. A laundry dryer comprising:
a laundry drum defining a receiving area for receiving laundry;
a sensor for measuring the amount of moisture in the laundry, the sensor including an electrode for measuring the conductance of the laundry and having an outer surface exposed to the receiving area;
an air intake receiving a cool air flow; and
an air passageway directing at least a portion of the cool air flow to the sensor to cool the electrode and resist formation of deposits on the electrodes.

34. The laundry dryer as claimed in claim 33, wherein the sensor includes the electrode being connected to a base component defining an opening in fluid communication with the air passageway for providing the cool air flow to pass through the base component and contact the electrode.

35. The laundry dryer as claimed in claim 34, wherein the electrode is formed as an elongated trough-shaped member defining an internal cavity, the outer surface of the electrode facing away from the base component and the internal cavity facing toward the base component and being in fluid communication with the opening and receiving the cool air flow from the opening.

36. The laundry dryer as claimed in claim 35, wherein the electrode includes at least one gap permitting the cool air flow to pass from the electrode into the receiving area of the laundry drum.

37. The laundry dryer as claimed in claim 35, further comprising a pipe extension extending from the opening into the electrode to direct the cool air flow against the electrode.

38. The laundry dryer as claimed in claim 35, wherein the base component defines a side opening, the cool air flow entering the electrode through the opening and exiting the electrode through the side opening.

39. A process for preventing deposit build-up on electrodes for conductance measuring in a laundry dryer, the process comprising controlling the temperature of the electrodes by means for heat reduction.

40. The process as claimed in claim 39, wherein the means for heat reduction are arranged on the rear of the electrodes.

41. The process as claimed in claim 39, wherein the means for heat reduction includes at least one of means for improving radiation of heat from the electrodes and cooling surfaces, which are connected to the electrodes.

42. The process as claimed in claim 39, wherein the means for heat reduction comprises means for air supply and the electrodes are arranged on a component in which openings are formed, cool air being supplied and removed from the electrodes, whereby the cool air is supplied through a middle opening and the cool air is removed through at least one side opening.

43. The process as claimed in claim 42, wherein the means for air supply are formed by defined faulty air openings in the vicinity of the electrodes, through which ambient air can be conveyed to the electrodes.

44. The process as claimed in claim 42, wherein the means for air supply comprises at least one of a fan and a source of compressed air.

45. The process as claimed in claim 39, wherein the electrodes are brought to a temperature which is below the processing temperature in the laundry dryer and below the temperature of metallic parts adjacent to the electrodes.

46. The process as claimed in claim 39, wherein the electrodes are cooled by air cooling.

47. The process as claimed in claim 39, wherein sub-pressure is set in a receiving area for laundry in the laundry dryer and the electrodes are supplied with cool air, in that ambient air is guided to the electrodes through defined faulty air openings.
